(19) United States
(12) Patent Application Publication
(10) Pub. No.: US 2016/0004089 A1
(43) Pub. Date: Jan. 7, 2016

(54) DISPLAY DEVICE AND DISPLAY SYSTEM

(71) Applicant: BOE TECHNOLOGY GROUP CO., LTD., Beijing (CN)

(72) Inventor: Wenbo LI, Beijing (CN)

(21) Appl. No.: 14/422,553

(22) PCT Filed: Jul. 25, 2014
(86) PCT No.: PCT/CN2014/083069

§ 371 Date: Feb. 19, 2015

(30) Foreign Application Priority Data
Dec. 27, 2013 (CN) 201310741825.4

(51) Int. Cl. G02B 27/26; G02F 1/1335; G02B 27/22; H04N 13/04

(52) U.S. Cl. CPC G02B 27/26; H04N 13/0434; G02F 1/133528; G02F 1/1336; G02F 1/133504; G02B 27/2264

(57) ABSTRACT

A display device and a display system are provided. The display device of the display system includes a display panel (2) and a first polarizer (1) provided on a side away from a display side of the display panel (2), and no polarizer is provided on the display side of the display panel (2). A pair of eyeglasses of the display system includes a polarizer provided on each lens of the eyeglasses and configured to read an image emitted by the display device. This simplifies the structure of the display device, improves the optical design, and no picture information can be seen by naked eyes and 3D or multi-view-point 2D display effect can be seen only when the eyeglasses is worn.

### TECHNICAL FIELD

At least one of embodiments of the disclosure relates to a display device and a display system.

### BACKGROUND

Technical innovations in liquid crystal display field come with people's efforts for satisfying various requirements in life and developers' insatiable revolutionary creation for products. Inherent defects of products lead scientific researchers to improve products continuously. For example, a liquid crystal display itself has a problem of viewing angle, and this brings an application and promotion of various broad-viewing-angle technologies, such as ADvanced Super dimension switch (short for ADS) technology, In-Plane Switching (short for IPS) technology and Multi-domain Vertical Alignment (short for MVA) technology. By employing a narrow-viewing-angle feature of the liquid crystal display, a normal display area can be limited to be within a front-viewing-angle area which is relatively narrow, and information displayed in a side display area cannot be seen clearly or be seen from left and right sides. In such a way, a user's privacy can be protected to some extent.

### SUMMARY

At least one of embodiments of the disclosure provides a display device and a display system, which simplify the structure of the display device, improve the optical design, and allow picture information invisible to naked eyes, and 3D (three dimensional) or multi-view-point 2D (two-dimensional) display effect can be seen only by a user with eyeglasses.

At least one of embodiments of the disclosure provides a display device, the display device includes a display panel and a first polarizer which is disposed away from a display side of the display panel, and no polarizer is disposed on the display side of the display panel.

At least one of embodiments of the disclosure further provides a display system which includes a pair of eyeglasses and the display device, and the eyeglasses includes a polarizer provided on a lens of the eyeglasses and configured to read an image emitted by the display device.

### BRIEF DESCRIPTION OF THE DRAWINGS

To clearly illustrate technical solutions of the embodiments of the disclosure, the drawings of the embodiments will be briefly described in the following. It is apparent that the described drawings are only related to some embodiments of the disclosure and thus are not limitative of the disclosure.

FIG. 1 is a schematic view illustrating a light-blocking-layer-grating type display device;

FIG. 2 is a schematic view illustrating another light-blocking-layer-grating type display device;

FIG. 3 is a schematic view illustrating a display device provided by a first embodiment of the disclosure;

FIG. 4 is a schematic view illustrating a liquid-crystal-grating type display device;

FIG. 5 is a schematic view illustrating a display device provided by a second embodiment of the disclosure;

FIG. 6 is a schematic view illustrating a shutter type 3D (three-dimensional) display device;

FIG. 7 is a schematic view illustrating a shutter type 3D (three-dimensional) eyeglasses; and

FIG. 8 is a schematic view illustrating a display device provided by a third embodiment of the disclosure.

### DETAILED DESCRIPTION

In order to make objects, technical details and advantages of the embodiments of the disclosure apparent, the technical solutions of the embodiments will be described in a clearly and fully understandable way in connection with the drawings related to embodiments of the disclosure. Apparently, the described embodiments are just a part but not all of the embodiments of the disclosure. Based on the described embodiments herein, those skilled in the art can obtain other embodiment(s), without any inventive work, which shall fall within the protection scope of the present disclosure.

The inventor of this application notices that the method of employing the narrow-viewing-angle feature of the liquid crystal and limiting the normal display area to be within a relatively narrow front-viewing-angle area may not be useful actually, because those who get confidential information from the computer intentionally or unintentionally often watch it directly behind the user or capture it with a hidden camera. The peeper may have a clear view of the information displayed on the computer from a certain angle without any awareness from the user. Therefore, it has become an objective for research technicians in the art to allow picture information on a LCD invisible to naked eyes, to allow 3D (three-dimensional) information visible to a user with a pair of 3D eyeglasses, and simultaneously provide visual impact and personal privacy protection.

With respect to the accompanying drawings and embodiments, implementations of the disclosure will be further described in detail below. The following embodiments are only used to describe the present disclosure and not limitative to the present disclosure.

A display device provided by at least one of embodiments of the disclosure includes a display panel and a first polarizer which is disposed away from a display side of the display panel, and no polarizer is disposed on the display side of the display panel. In an example, the display device further includes a backlight, and the polarizer is provided on a side of the display panel, close to the backlight. A display system provided by at least one of embodiments includes a pair of eyeglasses and a display device, the eyeglasses includes a polarizer provided on lenses of the eyeglasses and configured to read an image emitted by the display device, and the polarizer provided on each lens matches the first polarizer of the display device.

More detailed descriptions of the disclosure will be given below with respect to specific embodiments.

### First Embodiment

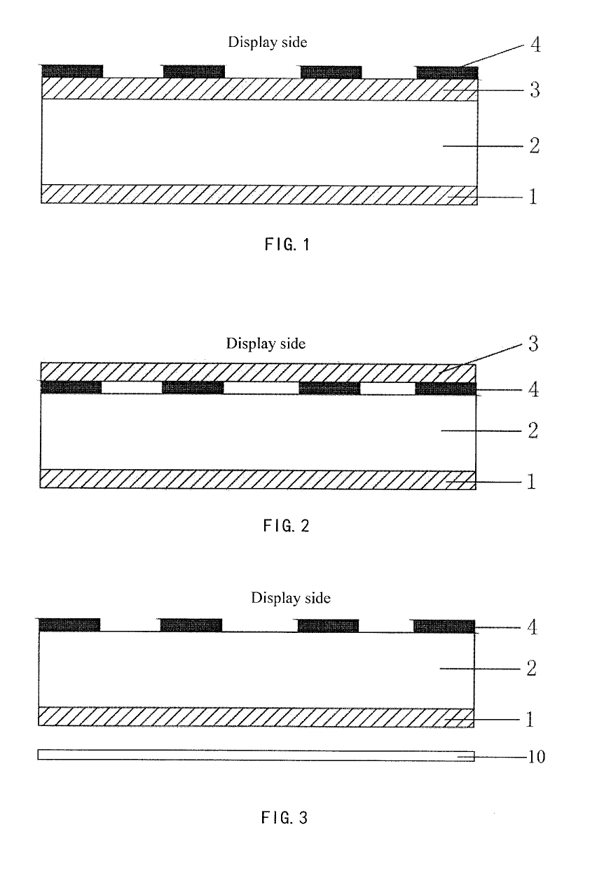

FIG. 1 and FIG. 2 respectively illustrate a display device adopting a light-blocking-layer-grating type to realize 3D or multiple views display. As illustrated in FIG. 1, a first polarizer 1 is provided below a display panel 2 (on a side away from the display side), a second polarizer 3 is provided over the display panel (on the display side), and a light-blocking layer 4 is provided on the second polarizer 3. As illustrated in FIG. 2, a first polarizer 1 is provided below the display panel, a light-blocking layer 4 is provided on the display panel, and a second polarizer 3 is provided on the light blocking layer 4. Such a display device allows anybody to see image information displayed, which has no function of privacy protection.

As illustrated in FIG. 3, the first embodiment of the disclosure provides a display system, which includes a display device and a pair of eyeglasses matching the display device. In the first embodiment, the second polarizer 3 is removed from the display device as illustrated in FIG. 1 and FIG. 2, instead of being provided on the eyeglasses. In an example, the display system provided by the first embodiment of the disclosure includes a display device (as illustrated in FIG. 3) and a pair of eyeglasses (not shown in the drawings). The display device includes a display panel 2, a first polarizer 1 is provided below the display panel 2 (on a side of the display panel away from the display side), and no polarizer is provided on the display side of the display panel 2. In an example, the display device further includes a backlight 10, the backlight 10 is disposed on a side of the display panel, opposite to the display side, and the first polarizer 1 is provided on the side of the display panel, close to the backlight 10. In an example, a grating structure is provided on the display panel 2 (namely on the display side of the display panel 2). For example, the grating structure is a light-blocking layer 4. The eyeglasses include a polarizer provided on each lens and configured to read an image emitted by the display device, and the polarizers on the two pieces of lenses of the eyeglasses are identical. For example, parameters, such as structures, sizes and materials of the two polarizers provided on the two pieces of lenses are the same. For example, the polarizers on the two pieces of lenses of the eyeglasses are identical in polarization direction; and therefore, the polarization effects produced by the polarizers are identical.

In the embodiment of the disclosure, it is required that the first polarizer 1 of the display device optically matches the polarizer on the eyeglasses, namely, images emitted by the display device can be read through the eyeglasses.

In an example, the light-blocking layer 4 is a black matrix, and the black matrix can be made of a resin material including a black colorant or made of black metal chromium, or the black matrix can be a printable film grating.

The display device of the display system in the embodiment of the disclosure is provided with the first polarizer 1 only on the side of the display panel, away from the display side, for example, on the side close to the backlight, so a normal 3D image cannot be seen by naked eyes, instead, a white image without any information is seen; and the 3D information can be seen normally by means of the eyeglasses provided with the polarizer thereon each.

Compared with the cases illustrated in FIG. 1 and FIG. 2, the display device in the embodiment of the disclosure omits the second polarizer 3 thereon, and simplifies the manufacturing process of the light-blocking layer 4 on the display device; and in the meantime, since a layer of an entire second polarizer 3 is omitted and the polarizer 3 is provided on the eyeglasses, the cost is saved significantly.

Besides, the display system of the first embodiment can realize a special display function, namely a user cannot see image information with naked eyes but can see the 3D image information by wearing the eyeglasses provided with a polarizer, and this allows the display system suitable for an application involving secret, such as military affairs and business and meets demands in different situations.

The display system in the first embodiment is also suitable for multi-view-point 2D display. By employing a grating to perform the light-splitting process and a pair of eyeglasses with a polarizer thereon each, the display system can also enable a viewer to see different 2D images at different angles, but only see a white image with naked eyes. Namely the multi-view-point 2D images cannot be read when viewed with naked eyes, instead, what is seen is a white image without information; and the multi-view-point 2D image information can be seen normally through the eyeglasses with the polarizer thereon each.

It can be seen from the above description that the display system in the first embodiment of the disclosure cannot perform the normal 2D display, because only the lower side of the display panel 2 is provided with the first polarizer 1, and only a white image can be seen with naked eyes. When 3D display or multi-view-point 2D display is performed, the eyeglasses in the first embodiment need to be used. By matching of the first polarizer 1 on the display device and the polarizers on the eyeglasses, the user's demands for viewing 3D and multi-view-point 2D images are satisfied.

### Second Embodiment

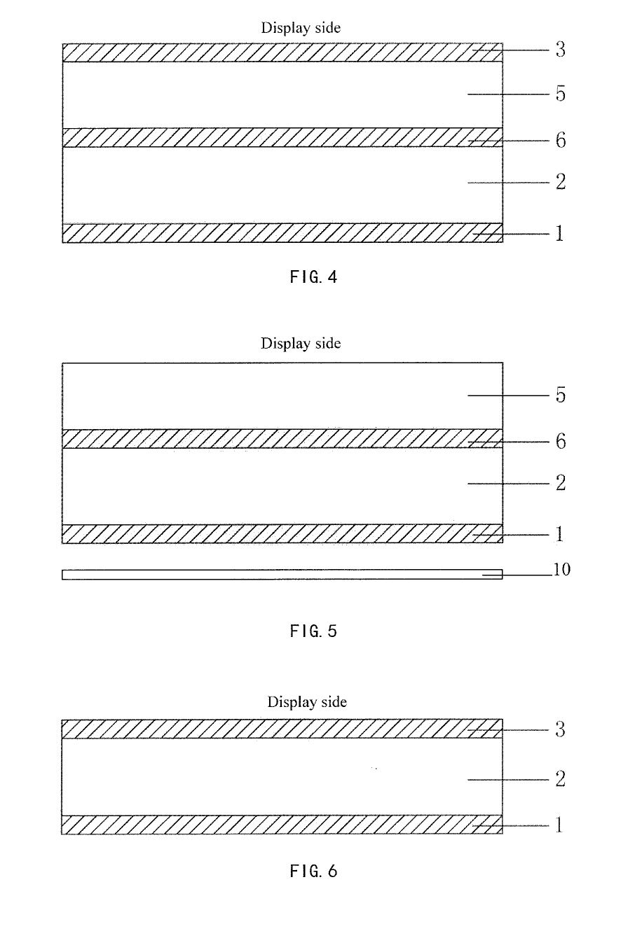

FIG. 4 illustrates a display device using a liquid crystal grating to realize 3D or multiple views display, and the display device can realize the switch between 2D and 3D. The liquid crystal grating is a twisted-nematic liquid crystal display device a normal white mode. A first polarizer 1 is provided below the display panel 2 (on a side of the display panel, away from the display side), a third polarizer 6 is provided on the display panel, a liquid crystal grating 5 is provided on the third polarizer 6, and a second polarizer 3 is provided on the liquid crystal grating 5. Similarly, such a display device allows anybody to see the image information, which has no function of privacy protection.

As illustrated in FIG. 5, the second embodiment of the disclosure provides a display system, which includes a display device and a pair of eyeglasses used together with the display device. In the second embodiment, the second polarizer 3 on the liquid crystal grating 5 is removed from the display device as illustrated in FIG. 4, instead, the second polarizer 3 is provided on the eyeglasses. In an example, the display system provided by the second embodiment of the disclosure includes a display device (as illustrated in FIG. 5) and a pair of eyeglasses (not shown in the drawings). The display device includes a display panel 2, a first polarizer 1 is provided below the display panel 2 (on a side of the display panel, away from the display side of the display panel), and no polarizer is disposed on the display side of the display panel 2. In an example, the display device further includes a backlight 10. The backlight 10 is disposed on a side of the display panel, opposite to the display side of the display panel. The first polarizer 1 is provided on the side of the display panel, close to the backlight 10. A third polarizer 6 is provided on the display panel 2. A grating structure is provided on the third polarizer 6 (namely on the display side of the display panel 2). For example, the grating structure is a liquid crystal grating 5. The eyeglasses include a polarizer provided on each lens and configured to read an image emitted by the display device, and the polarizers on the two pieces of lenses of the eyeglasses are identical. For example, parameters, such as structures, sizes and materials of the two polarizers provided on the two pieces of lenses are the same. For example, the polarizers on the two pieces of lenses of the eyeglasses are identical in polarization direction; and therefore, the polarization effects produced by the polarizers are identical.

In the embodiment of the disclosure, it is required that the first polarizer 1 of the display device optically matches the polarizer on the eyeglasses, namely images emitted by the display device can be read through the eyeglasses.

In performing the 3D or multi-view-point 2D display, no polarizer is provided on the liquid crystal grating 5 of the display device. Therefore, as for the 3D image or multi-view-point 2D image, the liquid crystal grating 5 has no function of splitting light but rotates the light emitted from the display panel 2 partially, so when a user views the display screen with naked eyes, the 3D image or multi-view-point 2D image appears to be random data information and the user cannot see a clear and useful image. When the eyeglasses matching the display device is used, the polarizer provided on the eyeglasses can filter useless light, thus the liquid crystal grating realizes the function of splitting light, and a clear 3D image or multi-view-point 2D image can be seen.

In performing normal 2D display, the liquid crystal grating generally adopts a twisted nematic (short for TN) liquid crystal device in normal white mode, such that the power consumption can be reduced without applying a voltage to the liquid crystal grating in performing the 2D display. For the display device provided by the second embodiment of the disclosure, since the polarizer above the liquid crystal grating 5 is removed, as long as a 2D signal is input into the display panel 2, light emitted from the display panel 2 cannot be shielded and the normal naked-eye 2D display can be performed regardless of whether the liquid crystal grating 5 is applied with a voltage or not. Therefore, regardless of whether the liquid crystal grating 5 is a TN device adopting a normal-white mode, or a VA, IPS, SADS device or the like employing a normal-black mode, the liquid crystal grating 5 can be applied with no voltage to perform normal 2D display, thus the power consumption in performing the 2D display is reduced, and the application of the liquid crystal grating 4 is expanded.

It can be seen from the above description that images can be viewed by naked eyes without use of a pair of eyeglasses when normal 2D display is performed by the display system in the second embodiment of the disclosure; and when the 3D display or multi-view-point 2D display is performed, the eyeglasses in the second embodiment is used, and this satisfies different requirements of different users in great extent.

### Third Embodiment

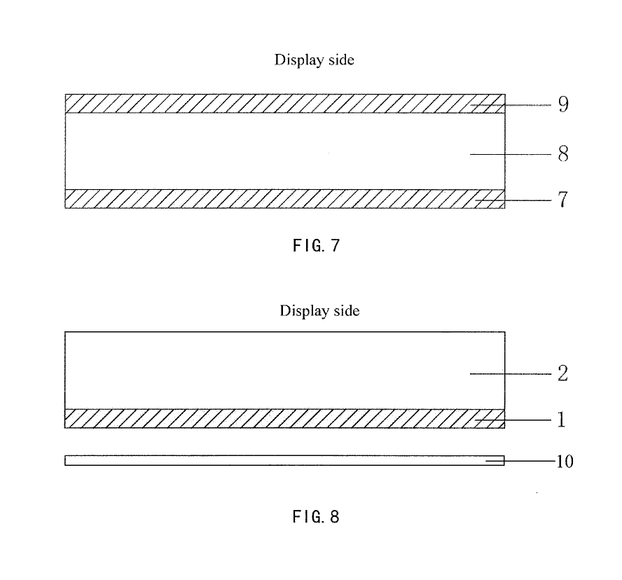

Generally, in a shutter type 3D display mode, at a first moment, all the images of the display panel are provided with left-eye images, and light can pass through the left lens of the 3D eyeglasses and be blocked by the right lens of the 3D eyeglasses; and at a second moment, all the images of the display panel are provided with right-eye images, and light can pass through the right lens of the 3D eyeglasses and be blocked by the left lens of the 3D eyeglasses. In the meantime, to improve the 3D display effect, a black frame can be inserted during the switching between the left-eye images and the right-eye images, to prevent the persistence of vision of human eyes from disturbing the left-eye images and the right-eye images and affecting the 3D display effect. FIG. 6 illustrates a shutter type 3D display device. A first polarizer 1 is provided below the display panel 2 (on a side away from the display side of the display panel), and a second polarizer 3 is provided on the display panel (on the display side of the display panel). FIG. 7 illustrates a pair of shutter type 3D eyeglasses used with the shutter type 3D display device. The shutter type 3D eyeglasses includes a liquid crystal shutter layer 8, a fourth polarizer 7 is provided below the liquid crystal shutter layer 8, and a fifth polarizer 9 is provided on the liquid crystal shutter layer 8. As for the often-used structure of shutter display system as illustrated in FIG. 6 and FIG. 7, polarization direction of the light emitted from the display panel 2 of the display device does not change, and the 3D display is realized by selectively turning on and off the liquid crystal shutters of the left lens and the right lens of the 3D eyeglasses at different times. But such display device and the 3D eyeglasses used with the display device also allow anybody who wears corresponding 3D eyeglasses to see the image information, which has no function of privacy protection.

As illustrated in FIG. 8, a display system in the third embodiment of the disclosure includes a display device and a pair of eyeglasses. The display device omits the polarizer disposed on the display side of the display panel without adding any other components. In an example, the display device in the third embodiment of the disclosure can be a liquid crystal shutter display device, which may include a display panel 2, a first polarizer 1 provided below the display panel 2 (on a side away from the display side of the display panel), and no polarizer is disposed on the display side of the display panel 2. In an example, the display device further includes a backlight 10. The backlight 10 is disposed on a side of the display panel, opposite to the display side of the display panel, and the first polarizer 1 is provided on the side of the display panel, close to the backlight 10. The eyeglasses in the third embodiment of the disclosure can be a liquid crystal shutter type 3D eyeglasses, which can include a liquid crystal shutter layer 8 configured to read the image emitted by the display device, and both sides of the liquid crystal shutter layer 8 are provided with a polarizer. For example, a fourth polarizer 7 is provided below the liquid crystal shutter layer 8, and a fifth polarizer 9 is provided on the liquid crystal shutter layer 8.

In performing the 3D display, the fourth polarizer 7 of the liquid crystal shutter type 3D eyeglasses is required to be orthogonal to the first polarizer of the liquid crystal shutter display device, and 3D display can be realized.

In performing 2D display, it is only needed to keep both the left lens and the right lens of the liquid crystal shutter type 3D eyeglasses in a state of allowing light to pass through. For example, for a display system adopting a normal white mode, the normal 2D display can be realized by applying no voltage to both pieces of lenses; and for a display system adopting a normal black mode, it is needed to apply a voltage to the liquid crystal shutter type 3D eyeglasses to keep the eyeglasses in a state of allowing light to pass through, so as to realize the normal 2D display. In performing the 2D display, a liquid crystal shutter type 3D eyeglasses in which only a fourth polarizer 7 is provided below the liquid crystal shutter layer 8 can also be used to view normally 2D images.

In performing the multi-view-point 2D display, it is needed to keep the left lens and the right lens of the liquid crystal shutter type 3D eyeglasses in a same state, an image data stream A is input to an odd frame, and another image data stream B is input to an even frame. If the liquid crystal shutter type 3D eyeglasses is in an open state in the odd frame and in a closed state in the even frame, only the image data stream A can be seen by using the liquid crystal shutter type 3D eyeglasses; and if the liquid crystal shutter type 3D eyeglasses is in a closed state in the odd frame and in an open state in the even frame, only the 2D image data stream B can be seen.

It can be seen from the above description that when the display panel is viewed without using the liquid crystal shutter type 3D eyeglasses in the third embodiment of the disclosure, as for the 2D display, multi-view-point 2D display and 3D display, only a white image without information can be seen, which prevents peeping and protects privacy of a user.

To sum up, the display system in embodiments of the disclosure can prevent peeping and 3D display of a display device. Embodiments of the disclosure provide solutions of preventing peeping for the light-blocking-layer grating using a parallax barrier method, the liquid crystal grating and the liquid crystal shutter type 3D eyeglasses, and by simplifying the structure of the display device and improving the optical design, no picture information can be seen with naked eyes, while the 3D or multi-view-point 2D display effect can be seen only when a pair of 3D eyeglasses is worn. As for the liquid crystal shutter display, embodiments of the disclosure can realize the original 3D display effect or multi-view-point 2D display effect by only omitting the polarizer on the display side of the display panel without adding other components. Thus, the process is simplified, the cost is saved, and the display system is suitable for display application involving secret, such as military affairs, business and so on.

The described above is only some preferred embodiments of the present disclosure. It is noted that the ordinary skilled in the art can make various variations and modifications without departing from the technical principle of the present disclosure, therefore, these variations and modifications belong to the scope of the present disclosure.

This application claims the benefit of Chinese Patent Application No. 201310741825.4, filed on Dec. 27, 2013, which is hereby entirely incorporated by reference.

1. A display device, comprising a display panel and a first polarizer provided on a side away from a display side of the display panel, wherein no polarizer is provided on the display side of the display panel.

2. The display device according to claim 1, further comprising a backlight provided on a side of the display panel, opposite to the display side, wherein the first polarizer is provided on the side of the display panel, close to the backlight.

3. The display device according to claim 1, further comprising a grating structure provided on the display side of the display panel.

4. The display device according to claim 3, wherein the grating structure comprises a light-blocking-layer grating or a liquid crystal grating.

5. The display device according to claim 4, further comprising a third polarizer, wherein where the grating structure comprises the liquid crystal grating, the third polarizer is provided between the liquid crystal grating and the display panel.

6. A display system, comprising a pair of eyeglasses and a display device according to claim 1, wherein the eyeglasses comprises a polarizer provided on each lens and configured to read an image emitted by the display device.

7. The display system according to claim 6, wherein the polarizer provided on each lens matches the first polarizer of the display device.

8. The display system according to claim 6, wherein the polarizers on two pieces of the lenses of the eyeglasses are identical in polarization direction.

9. The display system according to claim 6, wherein the eyeglasses further comprises a liquid crystal shutter layer, both sides of the liquid crystal shutter layer are provided with a polarizer, and the liquid crystal shutter layer is configured to read the image emitted by the display device.

10. The display device according to claim 2, further comprising a grating structure provided on the display side of the display panel.

11. The display device according to claim 10, wherein the grating structure comprises a light-blocking-layer-grating or a liquid crystal grating.

12. The display system according to claim 7, wherein the polarizers on two pieces of the lenses of the eyeglasses are identical in polarization direction.

13. The display system according to claim 7, wherein the eyeglasses further comprises a liquid crystal shutter layer, both sides of the liquid crystal shutter layer are provided with a polarizer, and the liquid crystal shutter layer is configured to read the image emitted by the display device.

14. The display system according to claim 8, wherein the eyeglasses further comprises a liquid crystal shutter layer, both sides of the liquid crystal shutter layer are provided with a polarizer, and the liquid crystal shutter layer is configured to read the image emitted by the display device.

15. The display system according to claim 12, wherein the eyeglasses further comprises a liquid crystal shutter layer, both sides of the liquid crystal shutter layer are provided with a polarizer, and the liquid crystal shutter layer is configured to read the image emitted by the display device.
